(19) United States
(12) Patent Application Publication
(10) Pub. No.: US 2007/0164555 A1
(43) Pub. Date: Jul. 19, 2007

(54) Flat security element

(76) Inventors: Thomas Mang, Reichersbeuern (DE); Theodor Burchard, Gmund (DE)

Correspondence Address: BACON & THOMAS, PLLC, 625 SLATERS LANE, FOURTH FLOOR, ALEXANDRIA, VA, 22314, US

(21) Appl. No.: 10/571,115

(22) PCT Filed: Sep. 7, 2004
(86) PCT No.: PCT/EP04/09970

§ 371 Date: Nov. 14, 2006

(30) Foreign Application Priority Data
Sep. 11, 2003 (DE) 10342253.6

(51) Int. Cl. B42D 15/00

(52) U.S. Cl. 283/72

(57) ABSTRACT

The invention relates to a flat security element for a security paper, value document or the like having a substrate (20) with two opposite main faces. According to the invention, at least one main face of the substrate (20) is provided with a fiber coating (22) to improve the embedding of the security element (12) in a security paper or a value document.

This invention relates to a flat security element for a security paper, value document or the like having a substrate with two opposite main faces. The invention relates further to a security paper and a value document having such a security element and to a method for producing a security paper having such a security element.

It is known to embed security elements in the form of threads or bands in security papers or value documents, such as bank notes, papers of value, identity cards or other papers at risk of forgery. “Security paper” will hereinafter be understood to mean paper that is already equipped with security elements such as a watermark, security thread, hologram patch, etc., but not yet printed. “Value document” will be understood to mean the printed security paper, e.g. the printed bank note.

The security threads or bands are as a rule incorporated into the paper during papermaking. For example, the security thread is introduced into the paper stock upon use of a cylinder paper machine and fed to the cylinder in such a way that the thread is embedded in the fiber structure of the paper during sheet formation.

Methods are also known for embedding a security thread in the paper in the form of a so-called windowed security thread, which is visible in certain areas on the surface of the paper of value. For example, EP-A 0 059 056 describes a method by which the security thread is fed to the papermaking screen outside the paper stock in such a way that it comes to lie on raised places provided thereon. At the places where the security thread rests on the raised places no paper can form on the side facing the screen, so that the security thread is visible in the finished paper at these places.

In practice it has turned out in the embedding of security threads with different widths that sheet formation is impaired above and below the thread by the drainage-inhibiting effect of the thread. This effect increases with the thread width and often leads to defects, such as holes, in the paper in the case of wide threads. To obtain sufficient sheet quality, the method known from EP-A-0 059 056 is therefore limited to the embedding of threads with a width up to about 1 mm to 1.5 mm.

To permit embedding of security bands with a width up to about 4 mm, it is therefore proposed in the print EP-A-0 625 431 to deliberately accept the defects appearing only on the back of the later security paper when using bands that are not too wide, and to cover them with one or two fault-free paper layers in a subsequent method step. This always ensures a minimum paper thickness even in the area of the defects, which conveys to the viewer a homogeneous impression of the paper surface.

In almost all security and bank-note papers, a thread coated with heat seal lacquer is incorporated into the paper on the paper machine as the security thread today. The heat seal lacquer serves to improve the anchorage of the thread in the paper. The width of these threads typically made of PET film is up to 3 mm, in rare cases also between 3 mm and 4 mm.

Fault-free sheet formation is increasingly impeded primarily with threads having a width of 3.5 mm or more. As a result so-called thread streaks appear, where the paper ply no longer forms a completely closed fiber structure in the area of the thread. The choice of thread and the thread design are therefore limited in practice to widths up to about 4.0 mm.

On these premises, the present invention is based on the problem of specifying a security element that avoids the disadvantages of the prior art. In particular, it should be possible to incorporate the security element into security papers or value documents reliably and with little effort, even if it has a large width or large surface area, in such a way as to yield a uniform and unimpaired appearance without defects.

This problem is solved by the security element having the features of the main claim. A security paper, a value document as well as a method for producing a security paper are the subject matter of the coordinated claims. Developments of the invention are the subject matter of the subclaims.

According to the invention, at least one main face of the substrate is provided with a three-dimensionally structured coating in the security element of the type stated at the outset.

According to the invention, the three-dimensionally structured coating may be a fiber coating, a foamed, embossed and/or filled coating.

In an advantageous embodiment, at least one main surface is provided with a fiber coating. Said fiber coating is integrated into the fibrous mesh of the paper during papermaking so as to prevent the paper ply from thinning in the area of the security element as known from the prior art.

The fiber coating is preferably formed by a textile fabric, in particular a woven, a knit, a felt, a nonwoven, or a flocking with or coating of single fibers. It is also possible to use a closed fiber material, such as paper, in particular cotton paper. The fabrics can be formed directly from the fibers, as in the case of felts or nonwovens, or from yarns, as in the case of wovens, knits or braids. A woven designates here a fabric produced by the interlacing of at least two different thread systems (warp and weft), while in knits the thread or threads are entwined in meshed loops. Felts are mechanically consolidated, woven sheets or fibrous webs. Nonwovens refer to nonwoven fabrics with usually randomly oriented fibers whose cohesion can already be given by the fibers' own adhesion. Furthermore, the nonwovens can also be mechanically or chemically consolidated.

According to a preferred embodiment of the invention, the fiber coating comprises synthetic fiber raw materials, in particular selected from the group of viscose, aramid, PVAL (polyvinyl alcohols), PET (polyethylene terephthalates), PA (polyamides) and polyolefins, preferably PP (polypropylenes).

According to a likewise preferred embodiment of the invention, the fiber coating comprises natural fibers, in particular selected from the group of wool, silk, cotton, plant fibers, paper fibers and cellulose.

The fiber coating can also comprise bicomponent fibers or multicomponent fibers, in particular made of the stated synthetic fiber raw materials or natural fibers.

Obviously, the stated fibers can also appear in the fiber coating in combination. For example, a partial area of the substrate of the security element can be coated with synthetic fibers, another partial area with natural fibers. In particular, the two main faces of the substrate can be provided with different fiber coatings.

According to an expedient embodiment of the invention, the fiber coating comprises a fibrous mat with a low weight per unit area, in particular with a weight per unit area of 8 to 30 g/m² or less, preferably of 15 g/m² or less.

According to another advantageous embodiment, the fiber coating comprises a woven with weft and warp threads made of different material. Expediently, one of the material threads is water-soluble. A fibrous mat or a fiber knit made of fibers with different diameter and/or different titer can also be advantageously used.

Expediently, the fiber coating is connected to the substrate via an adhesive layer. The adhesives used may be for example solvent-based adhesives, dispersions, hot-melts, heat seal lacquers, synthetic 1C and 2C adhesives, ionomers, styrene acrylates and mixtures thereof.

According to an advantageous development of the invention, the fiber coating is provided with an adhesive coating, in particular a heat-activable adhesive or a hot-melt adhesive, for embedding the security element in a security paper, value document or the like. The fiber coating can also have a hydrophilic coating as an additional coating. It may likewise be expedient to increase the polarity of the fibers by a corona or plasma pretreatment before embedding in the security paper or value document to obtain an improved bond with the stock fibers.

In a further advantageous embodiment, the three-dimensionally structured coating is an embossed coating. The embossed coating may be a heat-activable adhesive or a non-heat-activable adhesive, such as PUR, or non-heat-activable films, such as PA, PET, PP. The coating preferably comprises a heat-activable hot-melt adhesive. The embossing is produced e.g. by means of a structured embossing roll. The depth of the embossing is between about 1 to 10 μm, preferably about 3 to 6 μm. The embossing supports the depositing of fibers from the paper stock on the security element. The embossing is preferably equalized again in the press or dryer section or the smoothing machine, that is, after the actual sheet formation. The adhesives to be used are the above-mentioned adhesives.

In a further advantageous embodiment, the three-dimensionally structured coating is a foamed coating. The coating is in particular a heat-activable hot-melt adhesive or a film, such as HDPE, PP, OPP, PET, PA, which has been foamed e.g. by carbonates, hydrogencarbonates or other foaming agents. The pore structure present in the coating permits the depositing and penetration of fibers from the paper stock on the security element. Upon use of an adhesive, the pore sizes preferably range from about 1 to 200 μm, especially preferably from 40 to 50 μm. Upon use of foamed films, the pore sizes preferably range from about 50 to 500 μm, especially preferably from about 30 to 100 μm. The pore structure is preferably equalized again in the press or dryer section or the smoothing machine upon use of the heat-activable hot-melt adhesive, while the foaming is preferably retained upon use of a film.

In a further advantageous embodiment of the invention, the three-dimensionally structured coating is a filled coating. The coating is preferably a film, e.g. HDPE, PP, OPP, PET, PA, which has fillers. The fillers used are advantageously chalk, SiO₂, Al₂O₃, TiO₂, ZrO₂, talc, Acrosil, MgO or BaSO₄. The particle size preferably ranges up to about 40 μm in diameter. The filler content based on the film preferably ranges from about 5 to 20 wt %. The fillers preferably lead to a roughening of the film, which makes it more difficult for the fibers from the paper stock to run off the security element.

The inventive three-dimensionally structured coating can advantageously be additionally equipped with water-soluble properties. For example, a surface-structured PVA coating can be present in the security element. In the wet section of the paper machine the PVA coating is partially dissolved and prevents the pulp from washing away by integrating fibers from the paper stock. Sheet formation in the film area is thus facilitated.

It is of course also possible to combine the individual above-described inventive embodiments.

In an advantageous variant of the invention, only one main face of the substrate is provided with a three-dimensionally structured coating. This variant is used in particular when the security element is embedded in a security paper or value document in the manner of a windowed security thread.

If the security element is embedded in the paper all over, it has proved especially expedient if both main faces of the substrate are provided with a three-dimensionally structured coating. The main faces can be provided either with similar coatings or with different coatings.

The main face(s) of the substrate are expediently provided with the three-dimensionally structured coating all over for optimal embedding. Depending on the size of the security element, however, it may also suffice to provide the coating on only a partial area of the substrate thereof, for example an edge area.

It is also possible to apply a coating in sections on one side or a coating alternating on the two main faces. For further support of the anchorage of the security element in the paper, the security element can additionally be designed with perforations, preferably in the edge area of the element.

In a preferred embodiment, the security element is designed in the form of a security band which is intended for complete or partial embedding in a security paper or value document. The security band is designed in particular in the form of a rectangular band with length L and width B, the length L as a rule corresponding to a typical dimension of the security paper in which the security element is embedded. The inventive solution shows special advantages if the security band is formed with a width of about 4 mm to about 20 mm.

In other, likewise advantageous embodiments, the security element is designed in the form of a security stripe, a patch or another flat element. During production of a security paper the flat element is preferably applied to the still moist paper web, so that the fibers of the paper web can mesh with the fibers of the coating.

To further increase the falsification security, the security element can be equipped with an optically variable effect, in particular a diffraction pattern, a hologram, a color shift effect or other interference effects.

According to another preferred embodiment, the security element is provided with a printed image or with positive or negative gaps in an opaque layer, e.g. a metal layer, in the form of patterns or characters. The security element can also contain fluorescent substances, phosphorescent substances or magnetic substances as a further security feature. In all these embodiments, additional design options result compared to conventional security threads due to the greater possible width of the security element. For example, large-area print designs, such as flags, architectural motifs or portraits, can be used on a security band for the first time.

The invention also comprises a security paper for producing security or value documents, such as bank notes, identity cards or the like, which is equipped with an above-described security element, as well as a value document having such a security element. The security element can be completely embedded in the security paper or value document. Alternatively, the security element is embedded in the security paper or value document in the manner of a windowed security thread and is visible in window areas of the security paper or value document on the surface thereof. The security element can also form a pendulating security thread, which appears alternatingly on opposite surfaces of the security paper or value document.

To make the security element inside the security paper or value document as unobtrusive as possible in reflected light, the three-dimensional structuring of the security element surface can be selected so that it has substantially the same optical appearance as the paper substrate in which the security element is embedded. In particular, the fiber coating can have the same color as the paper substrate. If a fiber coating with an optically divergent appearance is alternatively selected, the contrast between security element and paper substrate can also be used deliberately as a design element.

In a method for producing a security paper of the described type, a paper web is formed in a first method step, a security band with a substrate with two opposite main faces being embedded completely or partly in the paper during sheet formation. According to the invention, at least one surface of a main face of the substrate is provided with a three-dimensional structure, in particular a fiber coating, before embedding.

According to preferred embodiments, the substrate of the security band is flocked or coated with single fibers or laminated with a fiber coating in the form of a textile fabric, in particular a woven, a knit, a felt or a nonwoven. It is advantageous to use here the synthetic fiber raw materials or natural fibers that are mentioned above.

For improved embedding of the security band in the security paper, the fiber coating is preferably provided with an adhesive coating. The fiber coating can also be provided with a hydrophilic coating, or the polarity of the fibers can be increased by a corona or plasma pretreatment to improve the embedding.

Further embodiments as well as advantages of the invention will be explained hereinafter with reference to the figures. For more clarity, the figures do without a representation that is true to scale and to proportion.

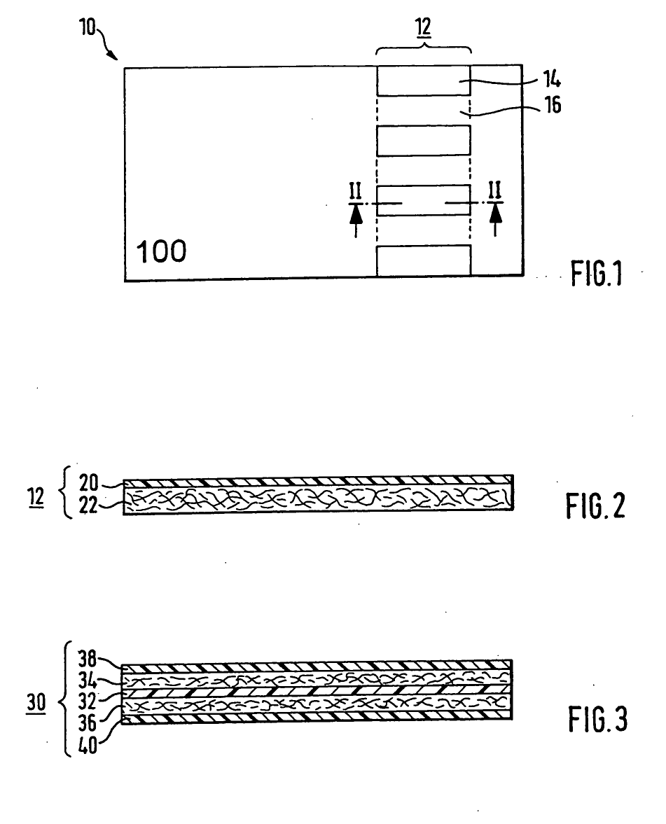

FIG. 1 shows a schematic representation of a bank note with a wide windowed security band according to one embodiment of the invention,

FIG. 2 shows the windowed security band of FIG. 1 in cross section along the line II-II, and

FIG. 3 shows a security band according to another embodiment of the invention in cross section.

The invention will be explained hereinafter by the example of a bank note. FIG. 1 shows a schematic representation of a bank note 10 with an embedded wide windowed security band 12 in a front view. The windowed security band 12 appears on the surface of the bank note 10 at window areas 14, while it is embedded inside the bank note 10 in the areas 16 therebetween.

The windowed security band 12 has a width of about 15 mm in this embodiment. To permit such a wide security band to be embedded in the bank note 10 without thread streaks, the windowed security band 12 is provided with a fiber coating on its underside. FIG. 2 shows schematically the structure of the windowed security band 12. A fibrous mat 22, in the embodiment a cotton mat, with a weight per unit area of about 15 g/m² is applied to a PET substrate film 20. The fibrous mat 22 is firmly connected to the substrate 20 via an adhesive layer of heat seal lacquer.

The windowed security band 12 is embedded in the paper web in the way known in the art during production of the security paper for the bank note 10. The fibrous mat 22 increases the adhesion of the cellulose fibers to the surface of the security band 12 and leads to closed sheet formation, despite the large width of the band, via the considerably improved embedding of the security band 12 in the fiber bond of the security paper. The security band 12 can be equipped with further security features not shown in the figure, for example a hologram element or a print design.

FIG. 3 shows a security band 30 for complete embedding in a security paper according to another embodiment of the invention. The security band 30 contains a PET or OPP substrate film 32 which is provided with a fiber coating 34, 36 on each side. In this embodiment the fiber coating is formed by a laminated knit of aramid fibers on each side. Further adhesive layers 38 and 40 on the fiber coatings 34 and 36 serve to strengthen the anchorage of the wide security band 30 in a security paper.

The described security band can be incorporated into a paper web not only with a cylinder paper machine. With a fourdrinier paper machine the security band can be supplied accordingly shortly before or shortly after the paper fiber layer leaves the screen in the same way as with a cylinder paper machine. language in preparation for U.S. examination; (iv) to remove limitations having an effect in a foreign country which is different and unintended under U.S. practice (i.e., changing “consisting of” to “comprising”); (v) to remove or amend original claim language that could be regarded as alternative expressions that are acceptable under foreign patent practice but possibly subject to objection under U.S. practice, typically having a broadening or neutral effect in the amended claim; and/or (vi) to improve the clarity or meaning of the original language.

In the case of amendments effectively changing an original claim element expressed as a “means plus function” that could raise a presumption of claim expression under 35 U.S.C. 112, 6^{th} paragraph to a structural expression or to an expression removing the presumption of a “means-plus-function” statement, it is not intended to narrow the claim so amended for purposes of patentability, but rather to place the claim in a form considered to be intended by the applicant from a foreign country where claim limitations described in terms of means-plus-function do not have the same effect as under U.S. practice. Thus, such amendments are intended to establish a full range of equivalents to the claim elements so amended under the U.S. doctrine of equivalents and beyond the range associated with “means-plus-function” expressions according to 35 U.S.C. 112, 6^{th} paragraph, just as if the claim so amended was presented originally in its amended form.

All rights are reserved to the original disclosed and claimed subject matter and any cancellation of claims is made without prejudice or disclaimer.

1. A flat security element for a security paper or value document, comprising a substrate with two opposite main faces, wherein at least one main face of the substrate is provided with a three-dimensionally structured coating.

2. The security element according to claim 1, wherein the three-dimensionally structured coating is at least one of a fiber, foamed, embossed and a filled coating.

3. The security element according to claim 1 wherein the coating is formed by a textile fabric.

4. The security element according to claim 2, wherein the fiber coating comprises synthetic fiber raw materials which are selected from the group consisting of viscose, aramid, PVAL, PET, PA and PP.

5. The security element according to claim 2, wherein the fiber coating comprises one or more natural fibers selected from the group consisting of wool, silk, cotton, plant fibers, paper fibers and cellulose.

6. The security element according to claim 2, wherein the fiber coating comprises bicomponent fibers or multicomponent fibers.

7. The security element according to claim 2, wherein the fiber coating comprises a fibrous mat with a weight per unit area of 8 to 30 g/m² or less.

8. The security element according to claim 2, wherein the fiber coating comprises a woven with weft and warp threads made of different material.

9. The security element according to claim 8, wherein one of the material threads is water-soluble.

10. The security element according to claim 2, wherein the fiber coating comprises a fibrous mat or a fiber knit made of fibers with either or both a different diameter and a different titer.

11. The security element according to claim 2, wherein the fiber coating is connected to the substrate via an adhesive layer.

12. The security element according to claim 2, wherein the fiber coating is provided with an adhesive coating for embedding or applying the security element in or to a security paper or value document.

13. The security element according to claim 2, wherein the fiber coating is provided with a hydrophilic coating.

14. The security element according to claim 2, wherein the polarity of the fibers of the fiber coating is increased by a corona or plasma pretreatment.

15. The security element according to claim 1, wherein only one main face of the substrate is provided with a three-dimensionally structured coating.

16. The security element according to claim 1, wherein both main faces of the substrate are provided with a three-dimensionally structured coating.

17. The security element according to claim 1, wherein the main face or faces of the substrate are provided with the three-dimensionally structured coating all over.

18. The security element according to claim 1, wherein the security element is configured in the form of a security band.

19. The security element according to claim 18, wherein the security band has a width of about 4 mm to about 20 mm.

20. The security element according to claim 1, wherein the security element is configured in the form of any one of a security stripe, a patch or another flat element.

21. The security element according to claim 1, wherein the security element is equipped with an optically variable effect.

22. The security element according to claim 1, wherein the security element is provided with a printed image or with positive or negative gaps in an opaque layer in the form of characters or patterns.

23. The security element according to claim 1, wherein the security element is selected from the group consisting of fluorescent substances, phosphorescent substances and magnetic substances.

24. A security paper for producing security or value documents, including a security element according to claim 1.

25. A value document comprising a security element according to claim 1

26. The security paper or value document according to claim 24, wherein the security element is completely embedded in or applied to the security paper or value document.

27. The security paper or value document according to claim 24, wherein the security element is embedded in the security paper or value document and is visible in window areas of the security paper or value document on the surface thereof.

28. The security paper or value document according to claim 26, wherein the three-dimensionally structured coating of the security element has substantially the same optical appearance as a paper substrate in which the security element is embedded.

29. A method for producing a security paper wherein a paper web is formed in a first method step, and a security element having a substrate with two opposite main faces is embedded completely or partly in the paper during sheet formation or applied to the paper after sheet formation, and wherein at least one main face of the substrate is provided with a three-dimensionally structured coating before embedding or application.

30. The method according to claim 29, wherein the main face is provided with a fiber coating.

31. The method according to claim 30, wherein the substrate of the security element is flocked or coated with single fibers.

32. The method according to claim 30, wherein the substrate of the security element is laminated with a fiber coating in the form of a textile fabric.

33. The method according to claim 30, wherein the fiber raw materials of the fiber coating comprise synthetic or natural fibers.

34. The method according to claim 30, wherein the fiber coating is provided with an adhesive coating for improved embedding of the security element in the security paper or application to the security paper.

35. The method according to claim 30, wherein the fiber coating is provided with a hydrophilic coating.

36. The method according to claim 30, wherein the polarity of the fibers of the fiber coating is increased by a corona or plasma pretreatment to improve the embedding.

37. The security element according to claim 1, wherein the fiber coating is formed by a fabric selected from the group consisting of a woven, a knit, a felt, a nonwoven and a flocking with or a coating of single fibers.

38. The security element according to claim 2, wherein the fiber coating comprises a fibrous mat with a weight per unit area of 15 g/m² or less.

39. The security element according to claim 21, wherein the optically variable effect is one or more effects selected from the group consisting of a diffraction pattern, a hologram and a color shift effect.

40. The method according to claim 30, wherein said synthetic fibers comprise one or more kinds selected from the group consisting of viscose, aramid, PVAL, PET, PA and PP.
